(19) United States
(12) Patent Application Publication
(10) Pub. No.: US 2007/0139829 A1
(43) Pub. Date: Jun. 21, 2007

(54) Micro-electromechanical system based arc-less switching

(75) Inventors: Stephen Daley Arthur, Glenville, NY (US); Kanakasabapathi Subramanian, Clifton Park, NY (US); William James Premerlani, Scotia, NY (US); John N. Park, Rexford, NY (US); Ajit Achuthan, Niskayuna, NY (US); Wensen Wang, Albany, NY (US); Joshua Isaac Wright, Greenbush, NY (US); Kristina Margaret Korosi, Cincinnati, OH (US); Somashekhar Basavaraj, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/314,336

(22) Filed: Dec. 20, 2005

(51) Int. Cl. H02H 7/00

(52) U.S. Cl. 361/2

(57) ABSTRACT

A system is presented. The system includes a first micro-electromechanical system switch. Further, the system includes arc suppression circuitry coupled to the first micro-electromechanical system switch, wherein the arc suppression circuitry comprises a balanced diode bridge and is configured to facilitate suppression of an arc formation between contacts of the first micro-electromechanical system switch.

### BACKGROUND

Embodiments of the invention relate generally to a switching device for switching off a current in a current path, and more particularly to micro-electromechanical system based switching devices.

A circuit breaker is an electrical device designed to protect electrical equipment from damage caused by faults in the circuit. Traditionally, most conventional circuit breakers include bulky electromechanical switches. Unfortunately, these conventional circuit breakers are large in size thereby necessitating use of a large force to activate the switching mechanism. Additionally, the switches of these circuit breakers generally operate at relatively slow speeds. Furthermore, these circuit breakers are disadvantageously complex to build and thus expensive to fabricate. In addition, when contacts of the switching mechanism in conventional circuit breakers are physically separated, an arc is typically formed therebetween which continues to carry current until the current in the circuit ceases. Moreover, energy associated with the arc may seriously damage the contacts and/or present a burn hazard to personnel.

As an alternative to slow electromechanical switches, fast solid-state switches have been employed in high speed switching applications. As will be appreciated, these solid-state switches switch between a conducting state and a non-conducting state through controlled application of a voltage or bias. For example, by reverse biasing a solid-state switch, the switch may be transitioned into a non-conducting state. However, since solid-state switches do not create a physical gap between contacts when they are switched into a non-conducing state, they experience leakage current. Furthermore, due to internal resistances, when solid-state switches operate in a conducting state, they experience a voltage drop. Both the voltage drop and leakage current contribute to the generation of excess heat under normal operating circumstances, which may be detrimental to switch performance and life. Moreover, due at least in part to the inherent leakage current associated with solid-state switches, their use in circuit breaker applications is not possible.

### BRIEF DESCRIPTION

Briefly, in accordance with aspects of the present technique, a system is presented. The system includes a first micro-electromechanical system switch. Further, the system includes arc suppression circuitry coupled to the first micro-electromechanical system switch, wherein the arc suppression circuitry comprises a balanced diode bridge and is configured to facilitate suppression of an arc formation between contacts of the first micro-electromechanical system switch.

In accordance with another aspect of the present technique, a method for switching is presented. The method includes applying a pulse signal to a pulse circuit having a balanced diode bridge to generate a pulse circuit current through the balanced diode bridge. Additionally, the method includes diverting a load circuit current from the micro-electromechanical system switch to the pulse circuit responsive to the pulse circuit current. The method also includes switching the micro-electromechanical switch from a first closed state to a state to a second open state in presence of a reduced load circuit current across the micro-electromechanical system switch.

In accordance with further aspects of the present technique a system is presented. The system includes switching circuitry comprising a micro-electromechanical system switch configured to facilitate switching the system switching the system from a first state to a second state. Further, the system includes arc suppression circuitry coupled to the switching circuitry, wherein the arc suppression circuitry is configured to facilitate suppression of an arc formation between contacts of the micro-electromechanical system switch. The system also includes detection circuitry coupled to the arc suppression circuitry and configured to facilitate determining existence of a switch condition. In addition, the system includes triggering circuitry coupled to the arc suppression circuitry and the decision circuitry, wherein the triggering circuitry is configured to generate a fault signal responsive to the switch condition, and wherein the switch condition is configured to facilitate initiating opening of the micro-electromechanical system switch.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary MEMS based switching system, in accordance with aspects of the present technique;

FIG. 2 is schematic diagram illustrating the exemplary MEMS based switching system depicted in FIG. 1, in accordance with aspects of the present invention;

FIGS. 3-5 are schematic flow charts illustrating an example operation of the MEMS based switching system illustrated in FIG. 2, in accordance with aspects of the present invention;

FIG. 6 is schematic diagram illustrating a series-parallel array of MEMS switches, in accordance with aspects of the present invention;

FIG. 7 is schematic diagram illustrating a graded MEMS switch, in accordance with aspects of the present invention;

FIG. 8 is a flow diagram depicting an operational flow of a system having the MEMS based switching system illustrated in FIG. 1, in accordance with aspects of the present invention; and

FIG. 9 is a graphical representation of experimental results representative of turn off of the switching system, in accordance with aspects of the present technique.

### DETAILED DESCRIPTION

In accordance with one or more embodiments of the present invention, systems and methods for micro-electromechanical system based arc-less switching is described herein. In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated.

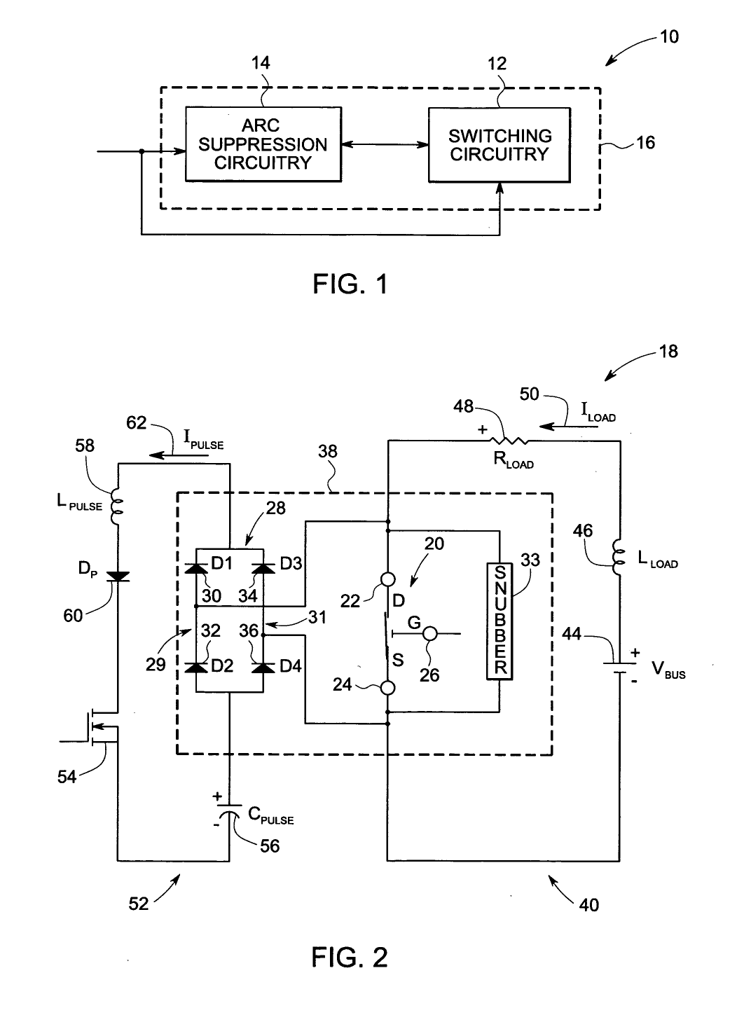

FIG. 1 illustrates a block diagram of an exemplary arc-less micro-electromechanical system switch (MEMS) based switching system 10, in accordance with aspects of the present invention. As illustrated in FIG. 1, the arc-less MEMS based switching system 10 is shown as including MEMS based switching circuitry 12 and arc suppression circuitry 14, where the arc suppression circuitry 14 is operatively coupled to the MEMS based switching circuitry 12. In certain embodiments, the MEMS based switching circuitry 12 may be integrated in its entirety with the arc suppression circuitry 14 in a single package 16, for example. In other embodiments, only certain portions or components of the MEMS based switching circuitry 12 may be integrated with the arc suppression circuitry 14.

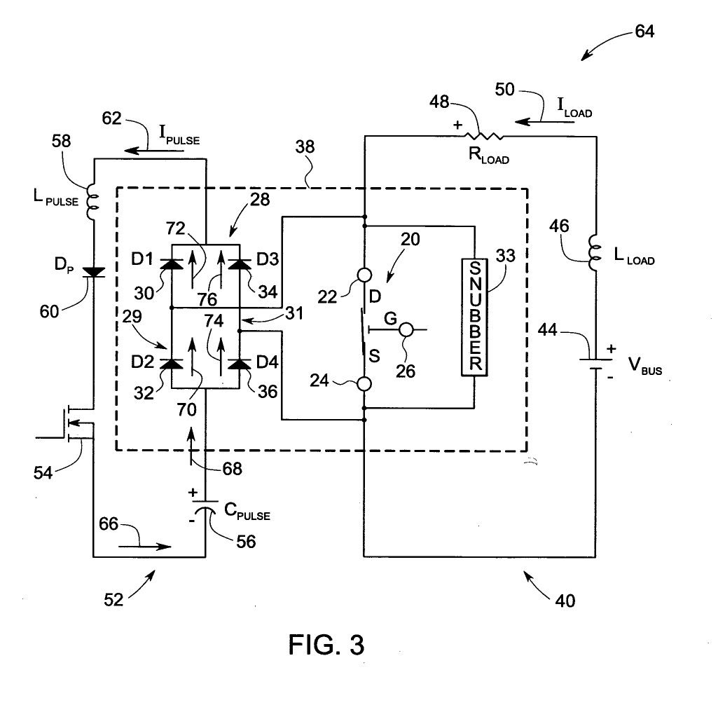

In a presently contemplated configuration as will be described in greater detail with reference to FIGS. 2-5, the MEMS based switching circuitry 12 may include one or more MEMS switches. Additionally, the arc suppression circuitry 14 may include a balanced diode bridge and a pulse circuit. Further, the arc suppression circuitry 14 may be configured to facilitate suppression of an arc formation between contacts of the one or more MEMS switches. It may be noted that the arc suppression circuitry 14 may be configured to facilitate suppression of an arc formation in response to an alternating current (AC) or a direct current (DC).

Turning now to FIG. 2, a schematic diagram 18 of the exemplary arc-less MEMS based switching system depicted in FIG. 1 is illustrated in accordance with one embodiment. As noted with reference to FIG. 1, the MEMS based switching circuitry 12 may include one or more MEMS switches. In the illustrated embodiment, a first MEMS switch 20 is depicted as having a first contact 22, a second contact 24 and a third contact 26. In one embodiment, the first contact 22 may be configured as a drain, the second contact 24 may be configured as a source and the third contact 26 may be configured as a gate. Furthermore, as illustrated in FIG. 2, a voltage snubber circuit 33 may be coupled in parallel with the MEMS switch 20 and configured to limit voltage overshoot during fast contact separation as will be explained in greater detail hereinafter. In certain embodiments, the snubber circuit 33 may include a snubber capacitor (not shown) coupled in series with a snubber resistor (not shown). The snubber capacitor may facilitate improvement in transient voltage sharing during the sequencing of the opening of the MEMS switch 20. Furthermore, the snubber resistor may suppress any pulse of current generated by the snubber capacitor during closing operation of the MEMS switch 20. In certain other embodiments, the voltage snubber circuit 33 may include a metal oxide varistor (MOV) (not shown).

In accordance with further aspects of the present technique, a load circuit 40 may be coupled in series with the first MEMS switch 20. The load circuit 40 may include a voltage source V_{BUS} 44. In addition, the load circuit 40 may also include a load inductance 46 L_{LOAD,} where the load inductance L_{LOAD} 46 is representative of a combined load inductance and a bus inductance viewed by the load circuit 40. The load circuit 40 may also include a load resistance R_{LOAD} 48 representative of a combined load resistance viewed by the load circuit 40. Reference numeral 50 is representative of a load circuit current I_{LOAD} that may flow through the load circuit 40 and the first MEMS switch 20.

Further, as noted with reference to FIG. 1, the arc suppression circuitry 14 may include a balanced diode bridge. In the illustrated embodiment, a balanced diode bridge 28 is depicted as having a first branch 29 and a second branch 31. As used herein, the term “balanced diode bridge” is used to represent a diode bridge that is configured such that voltage drops across both the first and second branches 29, 31 are substantially equal. The first branch 29 of the balanced diode bridge 28 may include a first diode D1 30 and a second diode D2 32 coupled together to form a first series circuit. In a similar fashion, the second branch 31 of the balanced diode bridge 28 may include a third diode D3 34 and a fourth diode D4 36 operatively coupled together to form a second series circuit.

In one embodiment, the first MEMS switch 20 may be coupled in parallel across midpoints of the balanced diode bridge 28. The midpoints of the balanced diode bridge may include a first midpoint located between the first and second diodes 30, 32 and a second midpoint located between the third and fourth diodes 34, 36. Furthermore, the first MEMS switch 20 and the balanced diode bridge 28 may be tightly packaged to facilitate minimization of parasitic inductance caused by the balanced diode bridge 28 and in particular, the connections to the MEMS switch 20. It may be noted that, in accordance with exemplary aspects of the present technique, the first MEMS switch 20 and the balanced diode bridge 28 are positioned relative to one another such that the inherent inductance between the first MEMS switch 20 and the balanced diode bridge 28 produces a di/dt voltage less than a few percent of the voltage across the drain 22 and source 24 of the MEMS switch 20 when carrying a transfer of the load current to the diode bridge 28 during the MEMS switch 20 turn-off which will be described in greater detail hereinafter. In one embodiment, the first MEMS switch 20 may be integrated with the balanced diode bridge 28 in a single package 38 or optionally, the same die with the intention of minimizing the inductance interconnecting the MEMS switch 20 and the diode bridge 28.

Additionally, the arc suppression circuitry 14 may include a pulse circuit 52 coupled in operative association with the balanced diode bridge 28. The pulse circuit 52 may be configured to detect a switch condition and initiate opening of the MEMS switch 20 responsive to the switch condition. As used herein, the term “switch condition” refers to a condition that triggers changing a present operating state of the MEMS switch 20. For example, the switch condition may result in changing a first closed state of the MEMS switch 20 to a second open state or a first open state of the MEMS switch 20 to a second closed state. A switch condition may occur in response to a number of actions including but not limited to a circuit fault or switch ON/OFF request.

The pulse circuit 52 may include a pulse switch 54 and a pulse capacitor C_{PULSE} 56 series coupled to the pulse switch 54. Further, the pulse circuit may also include a pulse inductance L_{PULSE} 58 and a first diode D_{P} 60 coupled in series with the pulse switch 54. The pulse inductance L_{PULSE} 58, the diode D_{P} 60, the pulse switch 54 and the pulse capacitor C_{PULSE} 56 may be coupled in series to form a first branch of the pulse circuit 52, where the components of the first branch may be configured to facilitate pulse current shaping and timing. Also, reference numeral 62 is representative of a pulse circuit current I^{PULSE} that may flow through the pulse circuit 52.

In accordance with aspects of the present invention as will be described in further detail hereinafter, the MEMS switch 20 may be rapidly switched (e.g., on the order of picoseconds or nanoseconds) from a first closed state to a second open state while carrying a current albeit at a near-zero voltage. This may be achieved through the combined operation of the load circuit 40, and pulse circuit 52 including the balanced diode bridge 28 coupled in parallel across contacts of the MEMS switch 20.

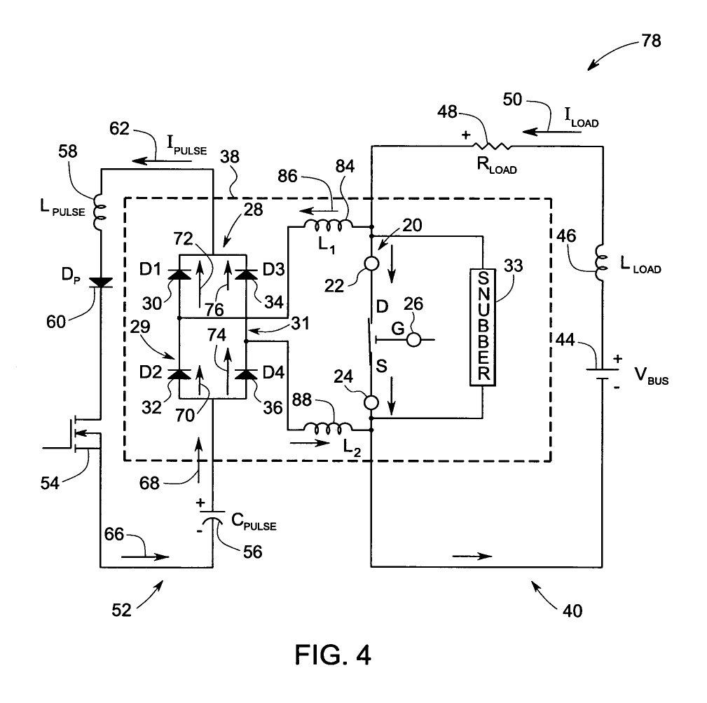

FIGS. 3-5 are used as schematic flow charts to illustrate an example operation of the arc-less MEMS based switching system 18 illustrated in FIG. 2. With continuing reference to FIG. 2, an initial condition of the example operation of the arc-less MEMS based switching system 18 is illustrated. The MEMS switch 20 is depicted as starting in a first closed state. Also, as indicated, there is a load current I_{LOAD} 50 which has a value substantially equal to V_{BUS}/R_{LOAD} in the load circuit 40.

Moreover, for discussion of this example operation of the arc-less MEMS based switching system 18, it may be assumed that a resistance associated with the MEMS switch 20 is sufficiently small such that the voltage produced by the load current through the resistance of MEMS switch 20 has only a negligible effect on the near-zero voltage difference between the mid-points of the diode bridge 28 when pulsed. For example, the resistance associated with the MEMS switch 20 may be assumed to be sufficiently small so as to produce a voltage drop of less than a few millivolts due to the maximum anticipated load current.

It may be noted that in this initial condition of the MEMS based switching system 18, the pulse switch 54 is in a first open state. Additionally, there is no pulse circuit current in the pulse circuit 52. Also, in the pulse circuit 52, the capacitor C_{PULSE} 56 may be pre-charged to a voltage V_{PULSE,} where V_{PULSE} is a voltage that can produce a half sinusoid of pulse current having a peak magnitude significantly greater (e.g., twice) the anticipated load current I_{LOAD} 50 during the transfer interval of the load current. It may be noted that C_{PULSE} 56 and L_{PULSE} 58 may be selected so as to resonate with each other.

FIG. 3 illustrates a schematic diagram 64 depicting a process of triggering the pulse circuit 52. It may be noted that detection circuitry (not shown) may be coupled to the pulse circuit 52. The detection circuitry may include sensing circuitry (not shown) configured to sense a level of the load circuit current I_{LOAD} 50 and/or a voltage level of the voltage source V_{BUS} 44, for example. Furthermore, the detection circuitry may be configured to detect a switch condition as described above. In one embodiment, the switch condition may occur due to the current level and/or the voltage level exceeding a predetermined threshold.

The pulse circuit 52 may be configured to detect the switch condition to facilitate switching the present closed state of the MEMS switch 20 to a second open state. In one embodiment, the switch condition may be a fault condition generated due to a voltage level or load current in the load circuit 40 exceeding a predetermined threshold level. However, as will be appreciated, the switch condition may also include monitoring a ramp voltage to achieve a given system-dependent ON time for the MEMS switch 20.

In one embodiment, the pulse switch 54 may generate a sinusoidal pulse responsive to receiving a trigger signal as a result of a detected switching condition. The triggering of the pulse switch 54 may initiate a resonant sinusoidal current in the pulse circuit 52. The current direction of the pulse circuit current may be represented by reference numerals 66 and 68. Furthermore, the current direction and relative magnitude of the pulse circuit current through the first diode 30 and the second diode 32 of the first branch 29 of the balanced diode bridge 28 may be represented by current vectors 72 and 70 respectively. Similarly, current vectors 76 and 74 are representative of a current direction and relative magnitude of the pulse circuit current through the third diode 34 and the fourth diode 36 respectively.

The value of the peak sinusoidal bridge pulse current may be determined by the initial voltage on the pulse capacitor C_{PULSE} 56, value of the pulse capacitor C_{PULSE} 56 and the value of the pulse inductance L_{PULSE} 58. The values for the pulse inductance L_{PULSE} 58 and the pulse capacitor C_{PULSE} 56 also determine the pulse width of the half sinusoid of pulse current. The bridge current pulse width may be adjusted to meet the system load current turn-off requirement predicated upon the rate of change of the load current (VBUS LLOAD) and the desired peak let-through current during a load fault condition. According to aspects of the present invention, the pulse switch 54 may be configured to be in a conducting state prior to opening the MEMS switch 20.

It may be noted that triggering of the pulse switch 54 may include controlling a timing of the pulse circuit current I_{PULSE} 62 through the balanced diode bridge 28 to facilitate creating a lower impedance path as compared to the impedance of a path through the contacts of the MEMS switch 20 during an opening interval. In addition, the pulse switch 54 may be triggered such that a desired voltage drop is presented across the contacts of the MEMS switch 20.

In one embodiment, the pulse switch 54 may be a solid-state switch that may be configured to have switching speeds in the range of nanoseconds to microseconds, for example. The switching speed of the pulse switch 54 should be relatively fast compared to the anticipated rise time of the load current in a fault condition. The current rating of the MEMS switch 20 is dependent on the rate of rise of the load current, which in turn is dependent on the inductance L_{LOAD} 46 and the bus supply voltage VBUS 44 in the load circuit 40 as previously noted. The MEMS switch 20 may be appropriately rated to handle a larger load current I_{LOAD} 50 if the load current I_{LOAD} 50 may rise rapidly compared to the speed capability of the bridge pulse circuit.

The pulse circuit current I_{PULSE} 62 increases from a value of zero and divides equally between the first and second branches 29, 31 of the balanced diode bridge 28. In accordance with one embodiment, the difference in voltage drops across the branches 29, 31 of the balanced diode bridge 28 may be designed to be negligible, as previously described. Further, as previously described, the diode bridge 28 is balanced such that the voltage drop across the first and second branches of the diode bridge 28 are substantially equal. Moreover, as the resistance of the MEMS switch 20 in a present closed state is relatively low, there is a relatively small voltage drop across the MEMS switch 20. However, if the voltage drop across the MEMS switch 20 happened to be larger (e.g., due to an inherent design of the MEMS switch), the balancing of the diode bridge 28 may be affected as the diode bridge 28 is operatively coupled in parallel with the MEMS switch 20. In accordance with aspects of the present invention, if the resistance of the MEMS switch 20 causes a significant voltage drop across the MEMS switch 20 then the diode bridge 28 may accommodate the resulting imbalance of the pulse bridge by increasing the magnitude of the peak bridge pulse current.

Referring now to FIG. 4, a schematic diagram 78 is illustrated in which opening of the MEMS switch 20 is initiated. As previously noted, the pulse switch 54 in the pulse circuit 52 is triggered prior to opening the MEMS switch 20. As the pulse current I_{PULSE} 62 increases, the voltage across the pulse capacitor C_{PULSE} 56 decreases due to the resonant action of the pulse circuit 52. In the ON condition in which the switch is closed and conducting, the MEMS switch 20 presents a path of relatively low impedance for the load circuit current I_{LOAD} 50.

Once the amplitude of the pulse circuit current I^{PULSE} 62 becomes greater than the amplitude of the load circuit current I_{LOAD} 50 (e.g., due to the resonant action of the pulse circuit 52), a voltage applied to the gate contact 26 of the MEMS switch 20 may be appropriately biased to switch the present operating state of the MEMS switch 20 from the first closed and conducting state to an increasing resistance condition in which the MEMS switch 20 starts to turn off (e.g., where the contacts are still closed but contact pressure diminishing due the switch opening process) which causes the switch resistance to increase which in turn causes the load current to start to divert from the MEMS switch 20 into the diode bridge 28.

In this present condition, the balanced diode bridge 28 presents a path of relatively low impedance to the load circuit current I_{LOAD} 50 as compared to a path through the MEMS switch 20, which now exhibits an increasing contact resistance. It may be noted that this diversion of load circuit current I_{LOAD} 50 through the MEMS switch 20 is an extremely fast process compared to the rate of change of the load circuit current I_{LOAD} 50. As previously noted, it may be desirable that the values of inductances L₁ 84 and L₂ 88 associated with connections between the MEMS switch 20 and the balanced diode bridge 28 be very small to avoid inhibition of the fast current diversion.

The process of current transfer from the MEMS switch 20 to the pulse bridge continues to increase the current in the first diode 30 and the fourth diode 36 while simultaneously the current in the second diode 32 and the third diode 34 diminish. The transfer process is completed when the mechanical contacts 22, 24 of the MEMS switch 20 are separated to form a physical gap and all of the load current is carried by the first diode 30 and the fourth diode 36.

Consequent to the load circuit current I_{LOAD} being diverted from the MEMS switch 20 to the diode bridge 28 in direction 86, an imbalance forms across the first and second branches 29, 31 of the diode bridge 28. Furthermore, as the pulse circuit current decays, voltage across the pulse capacitor C_{PULSE} 56 continues to reverse (e.g., acting as a “back electromotive force”) which causes the eventual reduction of the load circuit current I_{LOAD} to zero. The second diode 32 and the third diode 34 in the diode bridge 28 become reverse biased which results in the load circuit now including the pulse inductor L_{PULSE} 58 and the bridge pulse capacitor C_{PULSE} 56 and to become a series resonant circuit.

Turning now to FIG. 5, a schematic diagram 94 for the circuit elements connected for the process of decreasing the load current is illustrated. As alluded to above, at the instant that the contacts of the MEMS switch 20 part, infinite contact resistance is achieved. Furthermore, the diode bridge 28 no longer maintains a near-zero voltage across the contacts of the MEMS switch 20. Also, the load circuit current I_{LOAD} is now equal to the current through the first diode 30 and the fourth diode 36. As previously noted, there is now no current through the second diode 32 and the third diode 34 of the diode bridge 28.

Additionally, a significant switch contact voltage difference from the drain 24 to the source 26 of the MEMS switch 20 may now rise to a maximum of approximately twice the V_{BUS} voltage at a rate determined by the net resonant circuit which includes the pulse inductor L_{PULSE} 58, the pulse capacitor C_{PULSE} 56, the load circuit inductor L_{LOAD} 46, and damping due to the load resistor R_{LOAD} 48 and circuit losses. Moreover, the pulse circuit current I_{PULSE} 62, that is now equal to the load circuit current I_{LOAD} 50, may resonantly decrease to a zero value and to maintain the zero value due to the reverse blocking action of the diode bridge 28 and the diode Dₚ 60. The voltage across the pulse capacitor C_{PULSE} 56 has reversed resonantly to a negative peak and will maintain the negative peak value until the pulse capacitor C_{PULSE} 56 is recharged.

The diode bridge 28 may be configured to maintain a near-zero voltage across the contacts of the MEMS switch 20 until the contacts separate to open the MEMS switch 20, thereby preventing damage by suppressing any arc that would tend to form between the contacts of the MEMS switch 20 during opening. Additionally, the contacts of the MEMS switch 20 approach the opened state at a much reduced contact current through the MEMS switch 20. Also, any stored energy in the circuit inductance, the load inductance and the source may be transferred to the pulse circuit capacitor C_{PULSE} 56 and may be absorbed via voltage dissipation circuitry (not shown). The voltage snubber circuit 33 may be configured to limit voltage overshoot during the fast contact separation due to the inductive energy remaining in the interface inductance between the bridge and the MEMS switch. Furthermore, the rate of increase of reapply voltage across the contacts of the MEMS switch 20 during opening may be controlled via use of the snubber circuit (not shown).

It may also be noted that although a gap is created between the contacts of the MEMS switch 20 when in an open state, a leakage current may nonetheless exist between the load circuit 40 and the diode bridge circuit 28 around the MEMS switch 20. This leakage current may be suppressed via introduction of a secondary mechanical switch (not shown) series connected in the load circuit 40 to generate a physical gap. In certain embodiments, the mechanical switch may include a second MEMS switch.

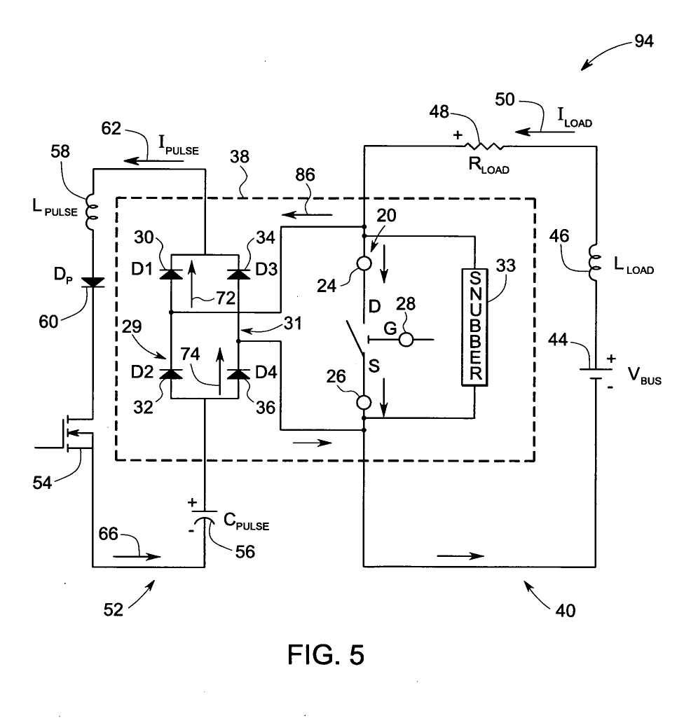

FIG. 6 illustrates an exemplary embodiment 96 wherein the switching circuitry 12 (see FIG. 1) may include multiple MEMS switches arranged in a series or series-parallel array, for example. Additionally, as illustrated in FIG. 6, the MEMS switch 20 may replaced by a first set of two or more MEMS switches 98, 100 electrically coupled in a series circuit. In one embodiment, at least one of the first set of MEMS switches 98, 100 may be further coupled in a parallel circuit, where the parallel circuit may include a second set of two or more MEMS switches (e.g., reference numerals 100, 102). In accordance with aspects of the present invention, a static grading resistor and a dynamic grading capacitor may be coupled in parallel with at least one of the first or second set of MEMS switches.

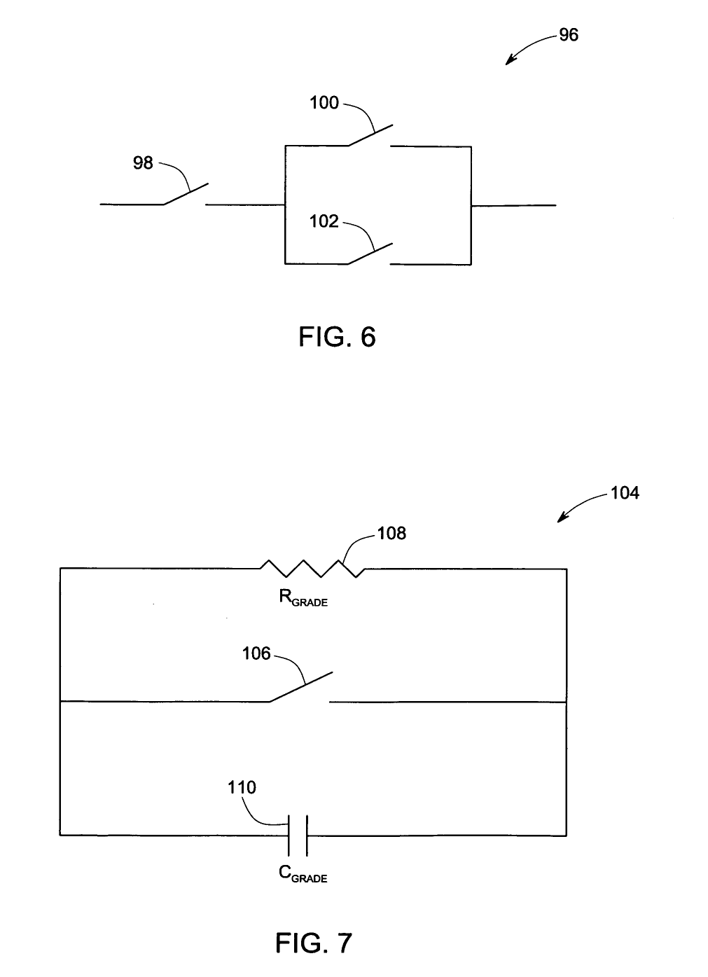

Referring now to FIG. 7, an exemplary embodiment 104 of a graded MEMS switch circuit is depicted. The graded switch circuit 104 may include at least one MEMS switch 106, a grading resistor 108, and a grading capacitor 110. The graded switch circuit 104 may include multiple MEMS switches arranged in a series or series-parallel array as for example illustrated in FIG. 6. The grading resistor 108 may be coupled in parallel with at least one MEMS switch 106 to provide voltage grading for the switch array. In an exemplary embodiment, the grading resistor 108 may be sized to provide adequate steady state voltage balancing (division) among the series switches while providing acceptable leakage for the particular application. Furthermore, both the grading capacitor 110 and grading resistor 108 may be provided in parallel with each MEMS switch 106 of the array to provide sharing both dynamically during switching and statically in the OFF state. It may be noted that additional grading resistors or grading capacitors or both may be added to each MEMS switch in the switch array.

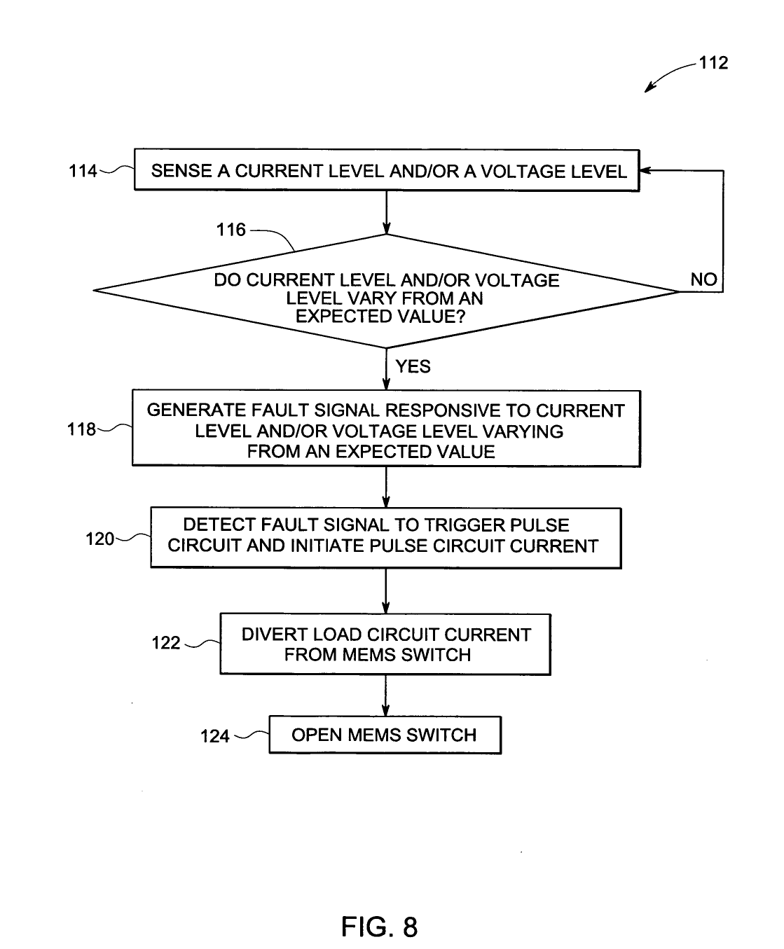

FIG. 8 is a flow chart of exemplary logic 112 for switching a MEMS based switching system from a present operating state to a second state. In accordance with exemplary aspects of the present technique, a method for switching is presented. As previously noted, detection circuitry may be operatively coupled to the arc suppression circuitry and configured to detect a switch condition. In addition, the detection circuitry may include sensing circuitry configured to sense a current level and/or a voltage level.

As indicated by block 114, a current level in a load circuit, such as the load circuit 40 (see FIG. 2), and/or a voltage level may be sensed, via the sensing circuitry, for example. Additionally, as indicated by decision block 116 a determination may be made as to whether either the sensed current level or the sensed voltage level varies from or exceeds an expected value. In one embodiment, a determination may be made (via the detection circuitry, for example) as to whether the sensed current level or the sensed voltage level exceeds respective predetermined threshold levels. Alternatively, voltage or current ramp rates may be monitored to detect a switch condition without a fault having actually occurred.

If the sensed current level or sensed voltage level varies or departs from an expected value, a switch condition may be generated as indicated by block 118. As previously noted, the term “switch condition” refers to a condition that triggers changing a present operating state of the MEMS switch. In certain embodiments, the switch condition may be generated responsive to a fault signal and may be employed to facilitate initiating opening of the MEMS switch. It may be noted that blocks 114-118 are representative of one example of generating a switch condition. However as will be appreciated, other methods of generating the switch condition are also envisioned in accordance with aspects of the present invention.

As indicated by block 120, the pulse circuit may be triggered to initiate a pulse circuit current responsive to the switch condition. Due to the resonant action of the pulse circuit, the pulse circuit current level may continue to increase. Due at least in part to the diode bridge 28, a near-zero voltage drop may be maintained across the contacts of the MEMS switch if the instantaneous amplitude of the pulse circuit current is significantly greater than the instantaneous amplitude of the load circuit current. Additionally, the load circuit current through the MEMS switch may be diverted from the MEMS switch to the pulse circuit as indicated by block 122. As previously noted, the diode bridge presents a path of relatively low impedance as opposed to a path through the MEMS switch, where a relatively high impedance increases as the contacts of the MEMS switch start to part. The MEMS switch may then be opened in an arc-less manner as indicated by block 124.

As previously described, a near-zero voltage drop across contacts of the MEMS switch may be maintained as long as the instantaneous amplitude of the pulse circuit current is significantly greater than the instantaneous amplitude of the load circuit current, thereby facilitating opening of the MEMS switch and suppressing formation of any arc across the contacts of the MEMS switch. Thus, as described hereinabove, the MEMS switch may be opened at a near-zero voltage condition across the contacts of the MEMS switch and with a greatly reduced current through the MEMS switch.

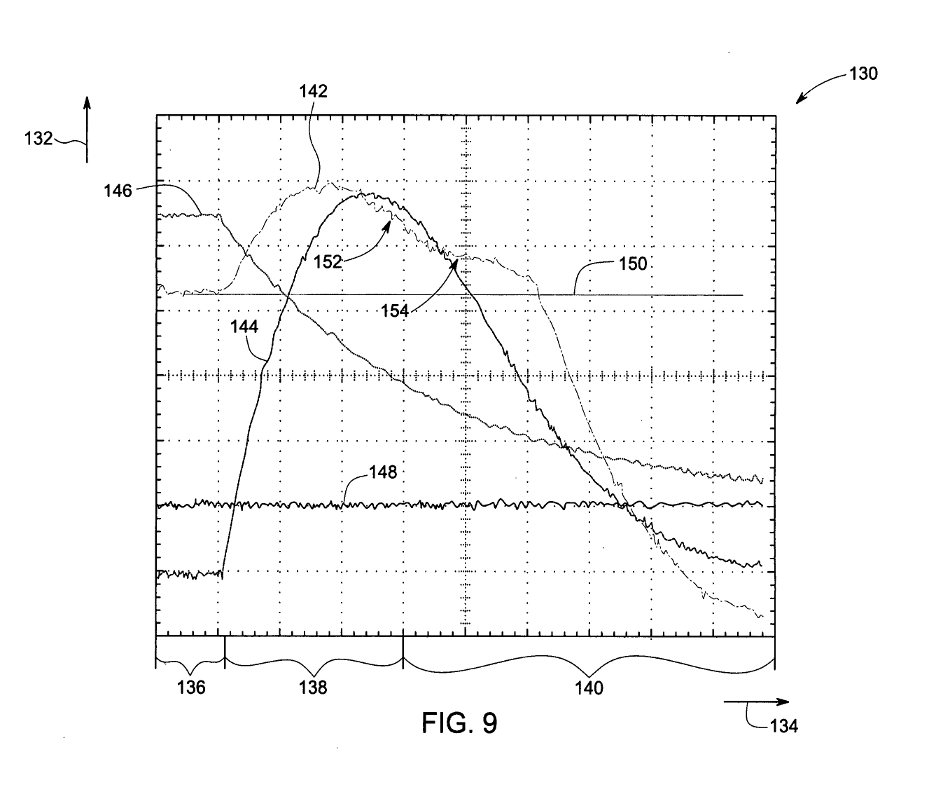

FIG. 9 is a graphical representation 130 of experimental results representative of switching a present operating state of the MEMS switch of the MEMS based switching system, in accordance with aspects of the present technique. As depicted in FIG. 9, a variation in amplitude 132 is plotted against a variation in time 134. Also, reference numerals 136, 138 and 140 are representative of a first section, a second section, and a third section of the graphical illustration 130.

Response curve 142 represents a variation of amplitude of the load circuit current as a function of time. A variation of amplitude of the pulse circuit current as a function of time is represented in response curve 144. In a similar fashion, a variation of amplitude of gate voltage as a function of time is embodied in response curve 146. Response curve 148 represents a zero gate voltage reference, while response curve 150 is the reference level for the load current prior to turn-off.

Additionally, reference numeral 152 represents region on the response curve 142 where the process of switch opening occurs. Similarly, reference numeral 154 represents a region on the response curve 142 where the contacts of the MEMS switch have parted and the switch is in an open state. Also, as can be seen from the second section 138 of the graphical representation 130, the gate voltage is pulled low to facilitate initiating opening of the MEMS switch. Furthermore, as can be seen from the third section 140 of the graphical representation 130, the load circuit current 142 and the pulse circuit current 144 in the conducting half of the balanced diode bridge are decaying.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a first micro-electromechanical system switch; and
arc suppression circuitry coupled to the first micro-electromechanical system switch, wherein the arc suppression circuitry comprises a balanced diode bridge and is configured to facilitate suppression of an arc formation between contacts of the first micro-electromechanical system switch.

2. The system of claim 1, wherein the arc suppression circuitry is configured to facilitate suppression of an arc formation in response to an alternating current or a direct current.

3. The system of claim 1, wherein the balanced diode bridge comprises a first branch and a second branch, and wherein the first branch comprises a first diode and a second diode coupled in a first series circuit and the second branch comprises a third diode and a fourth diode coupled in a second series circuit.

4. The system of claim 3, wherein the first micro-electromechanical system switch is coupled in parallel across midpoints of the balanced diode bridge, and wherein a first midpoint is located between the first and second diodes and a second midpoint is located between the third and fourth diodes.

5. The system of claim 1, wherein the first micro-electromechanical system switch is integrated with the balanced diode bridge in a single package.

6. The system of claim 1, further comprising a load circuit coupled to the first micro-electromechanical system switch and a pulse circuit coupled to the balanced diode bridge.

7. The system of claim 6, wherein the pulse circuit is configured to detect a fault condition and initiate opening of the micro-electromechanical system switch responsive to the fault condition.

8. The system of claim 1, further comprising a mechanical switch coupled in series with the first micro-electromechanical system switch and configured to suppress leakage current in the arc suppression circuitry.

9. The system of claim 8, wherein the mechanical switch comprises a second micro-electromechanical system switch.

10. The system of claim 1, further comprising a first plurality of micro-electromechanical switches electrically coupled in a series circuit.

11. The system of claim 10, wherein at least one of the first plurality of micro-electromechanical switches is further coupled in a parallel circuit comprising a second plurality of micro-electromechanical switches.

12. The system of claim 10, further comprising a grading resistor coupled in parallel with at least one of the plurality of micro-electromechanical system switches.

13. The system of claim 12, further comprising a grading capacitor configured to facilitate sharing of a transient recovery voltage and coupled in parallel with at least one of the plurality of micro-electromechanical system switches.

14. The system of claim 1, further comprising voltage snubbing circuitry coupled in parallel with the micro-electromechanical switch and configured to limit voltage magnitude and absorb inductive energy from the load circuit.

15. The system of claim 14, wherein the voltage snubbing circuitry comprises a metal oxide varistor.

16. A method for switching comprising:
applying a pulse signal to a pulse circuit having a balanced diode bridge to generate a pulse circuit current through the balanced diode bridge;
diverting a load circuit current from the micro-electromechanical system switch to the pulse circuit responsive to the pulse circuit current; and
switching the micro-electromechanical switch from a first closed state to a second open state in presence of a reduced load circuit current across the micro-electromechanical system switch.

17. The method of claim 16, wherein the load circuit current is diverted from the micro-electromechanical system switch to the pulse circuit without changing the load circuit current.

18. The method of claim 16, wherein the pulse circuit current divides equally between a first branch and a second branch of the balanced diode bridge to cause substantially equal voltage drops across the first branch and the second branch.

19. The method of claim 16, wherein the reduced load circuit current is non-zero.

20. The method of claim 16, further comprising receiving a fault signal, wherein the pulse signal is applied responsive to the fault signal.

21. The method of claim 20, wherein applying the pulse signal further comprises generating a resonant half sinusoid current within the pulse circuit responsive to the fault signal.

22. The method of claim 21, wherein applying the pulse signal comprises controlling a timing of the pulse circuit current through the balanced diode bridge to facilitate creating a lower impedance path as compared to an increasing resistance of contacts during an opening process of the micro-electromechanical switch.

23. The method of claim 16, wherein diverting the load circuit current comprises reducing contact pressure between contacts of the micro-electromechanical switch to facilitate initiating diversion of the load circuit current from the micro-electromechanical switch to the pulse circuit.

24. The method of claim 23, further comprising increasing current through a first diode in the first branch and a third diode in the second branch of the balanced diode bridge and decreasing current through a second diode in the first branch and a fourth diode in the second branch of the balanced diode bridge.

25. The method of claim 24, comprising switching the micro-electromechanical system switch from a first closed state to a second open state, wherein a physical gap is formed between the contacts of the micro-electromechanical switch in the second open state.

26. The method of claim 16, further comprising limiting voltage magnitude and absorbing inductive energy from the load circuit.

27. The method of claim 16, further comprising controlling a rate of voltage rise and voltage magnitude in the pulse circuit.

28. A system comprising:
switching circuitry comprising a micro-electromechanical system switch configured to facilitate switching the system from a first state to a second state;
arc suppression circuitry coupled to the switching circuitry, wherein the arc suppression circuitry is configured to facilitate suppression of an arc formation between contacts of the micro-electromechanical system switch;
detection circuitry coupled to the arc suppression circuitry and configured to facilitate determining existence of a switch condition; and
triggering circuitry coupled to the arc suppression circuitry and the decision circuitry, wherein the triggering circuitry is configured to generate a fault signal responsive to the switch condition, and wherein the switch condition is configured to facilitate initiating opening of the micro-electromechanical system switch.

29. The system of claim 28, wherein the arc suppression circuitry comprises:
a balanced diode bridge, wherein the balanced diode bridge is coupled in parallel with the micro-electromechanical system switch; and
a pulse circuit coupled to the balanced diode bridge,
wherein the arc suppression circuitry is configured to facilitate suppression of an arc formation between contacts of the micro-electromechanical switch in response to an alternating current or a direct current.

30. The system of claim 29, further comprising a load circuit coupled to the micro-electromechanical system switch.

31. The system of claim 28, wherein the first state is a conducting state of the micro-electromechanical system switch and the second state is a non-conducting state of the micro-electromechanical system switch.

32. The system of claim 28, wherein the detection circuitry comprises sensing circuitry, wherein the sensing circuitry is configured to sense a current level, a voltage level or both.
